(19) United States
(12) Patent Application Publication
(10) Pub. No.: US 2017/0262118 A1
(43) Pub. Date: Sep. 14, 2017

(54) SINGLE LAYER SENSOR ELECTRODE LAYOUT FOR EDGE AREA SENSING

(71) Applicant: SYNAPTICS INCORPORATED, San Jose, CA (US)

(72) Inventor: De-Quan MENG, Jiangsu Sheng (CN)

(21) Appl. No.: 15/135,501

(22) Filed: Apr. 21, 2016

(30) Foreign Application Priority Data
Mar. 8, 2016 (CN) 201610131186.3

(51) Int. Cl. G06F 3/041; G06F 3/044

(52) U.S. Cl. CPC G06F 3/0416; G06F 3/044; G06F 3/0412; G06F 3/0414

(57) ABSTRACT

A sensor electrode pattern is described that provides for capacitive sensing in an edge area of a host device. The sensor electrode pattern can be disposed in a single-layer configuration. An array of sensor electrodes disposed in the edge area can re-use input channels with sensor electrodes disposed in an active area of the host device.

### CROSS-REFERENCE TO RELATED APPLICATIONS

This application claims priority to Chinese Patent Application Serial Number 201610131186.3, filed Mar. 8, 2015, which is incorporated by reference in its entirety.

### BACKGROUND

Field of the Disclosure

Embodiments of disclosure generally relate to capacitive sensing and, more particularly, sensing force on an input surface using capacitive sensing.

Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

Embodiments of the present disclosure provide a single layer capacitive sensor. The capacitive sensor includes a substrate and an array of sensor electrode columns disposed on a first surface of the substrate and disposed along a first axis in a display area. The array of sensor electrode columns includes a last sensor electrode column disposed along a side of the display area. Each sensor electrode column includes a first plurality of sensor electrodes, a second plurality of sensor electrodes, one or more routing traces extending along the first axis coupling to the first plurality of sensor electrodes, and one or more routing traces extending along the first axis coupling to the second plurality of sensor electrodes. The capacitive sensor further includes an array of side sensor electrodes disposed on the first surface and disposed outside of the display area. The side sensor electrodes are configured to be driven with a sensing signal to detect an input object outside of the display area. At least one of the side sensor electrodes and a sensor electrode in the last sensor electrode column are coupled to a same channel.

Another embodiment of the present disclosure provides an input device having an array of sensor electrode columns disposed on a first surface of a substrate and disposed along a first axis in a display area. The array of sensor electrode columns includes a last sensor electrode column disposed along a side of the display area. Each sensor electrode column includes a first plurality of sensor electrodes, a second plurality of sensor electrodes, one or more routing traces extending along the first axis coupling to the first plurality of sensor electrodes, and one or more routing traces extending along the first axis coupling to the second plurality of sensor electrodes. The input device further includes an array of side sensor electrodes disposed on the first surface of the substrate and disposed outside of the display area, and a processing system communicatively coupled to the array of sensor electrode columns and the array of side sensor electrodes. At least one of the side sensor electrodes and a sensor electrode in the last sensor electrode column are coupled to a same channel. The processing system is configured to drive the side sensor with a sensing signal to detect an input object outside of the display area.

One embodiment of the present disclosure provides a processing system having a sensor module comprising sensor circuitry. The sensor module is configured to be coupled to an array of sensor electrode columns disposed on a first surface of a substrate and disposed along a first axis in a display area, wherein the array of sensor electrode columns includes a last sensor electrode column disposed along a side of the display area. The sensor module is configured to be coupled to a first plurality of sensor electrodes of each sensor electrode column via one or more routing traces extending along the first axis. The sensor module is configured to be coupled to a second plurality of sensor electrodes of each sensor electrode column via one or more routing traces extending along the first axis. The sensor module is configured to be coupled an array of side sensor electrodes disposed on the first surface and disposed outside of the display area and drive the side sensor electrodes with a sensing signal to detect an input object outside of the display area. The sensor module is configured to be coupled to at least one of the side sensor electrodes and a sensor electrode in the last sensor electrode column at a same channel of the sensor module.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of an exemplary input device, according to one embodiment described herein.

FIG. 2 is a schematic top view of a portion of an input device that illustrates a portion of a sensor electrode pattern that may be used to determine the positional information of an input object within a sensing region, according to one embodiment of the present disclosure

FIG. 3 is a schematic top view of a portion of an input device that illustrates a portion of an alternative embodiment of a sensor electrode pattern.

FIG. 4 is a schematic top view of a portion of an input device that illustrates a portion of an alternative embodiment of a sensor electrode pattern, having a different sizing of side sensor electrodes.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

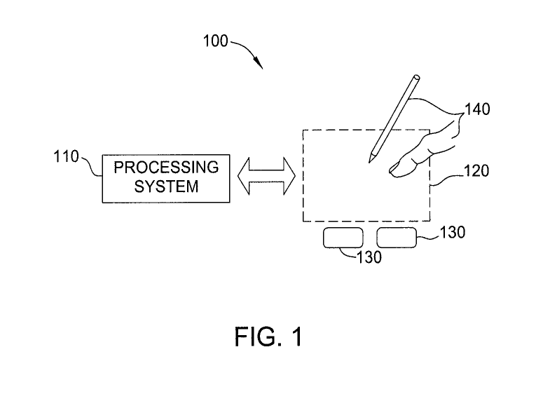

FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive, sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (lCs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

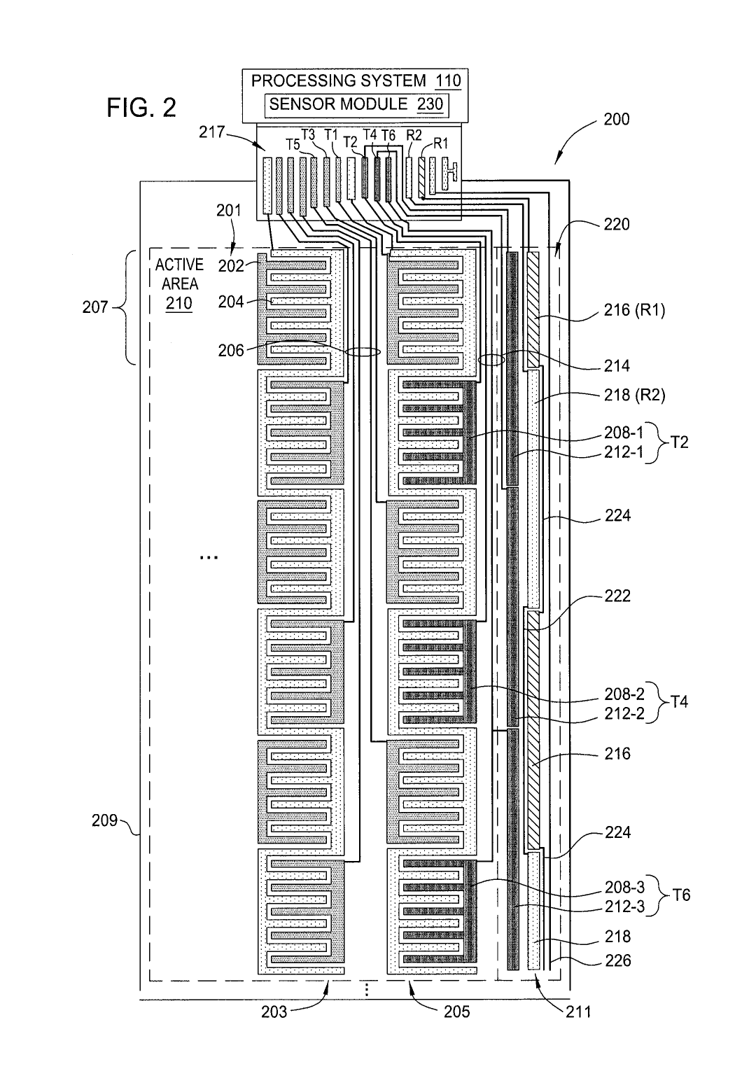

FIG. 2 is a schematic top view of a portion of an input device 200 that illustrates a portion of a sensor electrode pattern 201 that may be used to determine the positional information of an input object within a sensing region 120. One will note that the input device 200 may be formed as part of a larger input device 100, which is discussed above. The sensing region 120 includes an active area 210 and an edge area 220. In contrast to the active area 210 which in some embodiments encompasses a main display area of the input device but the bezel of the input device, the edge area 220 is sensing region that encompasses a region disposed along the boundary or the edge of the input device 200. In some embodiments, the edge area 220 may include at least part of a bezel portion of the input device 200. In other embodiments, the edge area 220 may encompass a region or space above, around, in and/or near a sidewall of the input device 200.

In one embodiment, the sensor electrode pattern 201 includes an array of sensor electrode columns 203 disposed along a first axis in a display area (i.e., active area 210) and that includes a plurality of sensor electrodes, such as sensor electrodes 202 and 204. As shown in FIG. 2, one or more routing traces 206 extending along the first axis are coupled to the sensor electrodes 202, and one or more other routing traces extending along the first axis are coupled to the other sensor electrodes 204. For sake of illustration, while FIG. 2 illustrates a pattern of rectangles and interlocking polygons to represent the sensor electrodes, this configuration is not meant to be limiting and in other embodiments, various other sensor shapes may be used as well. Sensor electrodes 202 and 204 are typically ohmically isolated from each other, by use of insulating materials or a physical gap formed between the electrodes to prevent them from electrically shorting each other. One will note that the sensor electrode pattern 201 of FIG. 2 may alternatively utilize various sensing techniques, such as mutual capacitive sensing, absolute capacitive sensing, elastive, resistive, inductive, magnetic acoustic, ultrasonic, or other useful sensing techniques, without deviating from the scope of the invention described herein.

In some configurations, two or more sensor electrodes may form a larger unit cell 207. A unit cell 207 includes a grouping of sensor electrodes that are repeated within a sensor electrode column 205 and/or in a repeating pattern across the sensing region 120 (e.g., multiple sensor electrode arrays). The unit cell 207 is the smallest unit that a symmetric grouping of sensor electrodes that can be broken into within a sensor electrode pattern formed across the sensing region 120. As illustrated in FIG. 2, in one example, the unit cell 207 includes at least a portion of the sensor electrode 204 and a sensor electrode 202.

In one embodiment, the sensor electrodes of the sensor electrode pattern 201 are arranged and interconnected in a single-layer configuration, i.e., disposed on a same surface of a substrate 209 of the input device 200. As illustrated in FIG. 2, the sensor electrodes of the sensor electrode pattern 201 may include a plurality of transmitter and receiver electrodes that are formed in a single layer on a surface of a substrate 209. In one configuration of the input device 200, each of the sensor electrodes may comprise one or more transmitter electrodes (e.g., sensor electrodes 202) that are disposed proximate to one or more receiver electrodes (e.g., sensor electrodes 204). In one example, a transcapacitive sensing method using the single layer sensor electrode design may operate by detecting the change in capacitive coupling between one or more of the driven transmitter sensor electrodes and one or more of the receiver electrodes, as similarly discussed above. In such embodiments, the transmitter and receiver electrodes may be disposed in such a way that jumpers and/or extra layers used to form the area of capacitive pixels are not required. That is, the sensor electrode pattern may be arranged without any jumpers within the active area 220 coupling any of the array of sensor electrode columns 203. In various embodiments, the transmitter electrodes and receiver electrodes may be formed in an array on the surface of the substrate 209 by first forming a blanket conductive layer on the surface of the substrate 209, and then performing an etching and/or patterning process (e.g., lithography and wet etch, laser ablation, etc.) that ohmically isolates each of the transmitter and receiver electrodes from each other. In other embodiments, the sensor electrodes may be patterned using deposition and screen printing methods. As illustrated in FIG. 2, these sensor electrodes may be disposed in an array that includes a column pattern of sensing elements, which may comprise one or more transmitter electrodes and one or more receiver electrodes. In one example, the blanket conductive layer used to form the transmitter electrodes and receiver electrodes comprises a thin metal layer (e.g., copper, aluminum, etc.) or a thin transparent conductive oxide layer (e.g., ATO, ITO, Zinc oxide) that is deposited using convention deposition techniques known in the art (e.g., PVD, CVD). In various embodiments, patterned isolated conductive electrodes (e.g., electrically floating electrodes) may be used to improve visual appearance. In one or more of the embodiments described herein, the sensor electrodes are formed from a material that is substantially optically clear, and thus, in some configurations, can be disposed between a display device and the input device user.

The areas of localized capacitive coupling formed between at least a portion of one or more sensor electrodes 202 and at least a portion of one or more sensor electrodes 204 may be termed a “capacitive pixel,” or also referred to herein as the sensing element. For example in. FIG. 2, the capacitive coupling in a sensing element may be created by the electric field formed between at least a portion of the sensor electrodes 204 and a sensor electrode 202, which changes as the proximity and motion of input objects across the sensing region changes.

In some embodiments, the sensing elements are “scanned” to determine these capacitive couplings. The input device 200 may be operated such that one transmitter electrode transmits at one time, or multiple transmitter electrodes transmit at the same time. Where multiple transmitter electrodes transmit simultaneously, these multiple transmitter electrodes may transmit the same transmitter signal and effectively produce an effectively larger transmitter electrode, or these multiple transmitter electrodes may transmit different transmitter signals. In one example, the transmitter electrodes are the sensor electrodes 202 and the receiver electrodes are the sensor electrodes 204. For example, in one configuration, multiple sensor electrodes 202 transmit different transmitter signals according to one or more coding schemes that enable their combined effects on the resulting signals received by the receiving sensor electrodes, or sensor electrodes 204, to be independently determined. The direct effect of a user input which is coupled to the device may affect (e.g. reduce the fringing coupling) of the resulting signals. Alternately, a floating electrode may be coupled to the input and to the transmitter and receiver and the user input may lower its impedance to system ground and thus reduce the resulting signals. In a further example, a floating electrode may be displaced toward the transmitter and receiver which increases their relative coupling. The receiver electrodes, or a corresponding sensor electrode 204, may be operated singly or multiply to acquire resulting signals created from the transmitter signal. The resulting signals may be used to determine measurements of the capacitive couplings at the capacitive pixels, which are used to determine whether an input object is present and its positional information, as discussed above. A set of values for the capacitive pixels form a “capacitive image” (also “capacitive frame” or “sensing image”) representative of the capacitive couplings at the pixels. In various embodiments, the sensing image, or capacitive image, comprises data received during a process of measuring the resulting signals received with at least a portion of the sensing elements distributed across the sensing region 120. The resulting signals may be received at one instant in time, or by scanning the rows and/or columns of sensing elements distributed across the sensing region 120 in a raster scanning pattern (e.g., serially polling each sensing element separately in a desired scanning pattern), row-by-row scanning pattern, column-by-column scanning pattern or other useful scanning technique. In many embodiments, the rate that the “sensing image” is acquired by the input device 100, or sensing frame rate, is between about 60 and about 180 Hertz (Hz), but can be higher or lower depending on the desired application.

In some touch screen embodiments, the sensing elements are disposed on a substrate 209 of an associated display device. For example, the sensor electrodes 202 and/or the sensor electrodes 204 may be disposed on a polarizer, a color filter substrate, or a glass sheet of an LCD. As a specific example, the sensor electrodes 202 and 204 may be disposed on a TFT (Thin Film Transistor) substrate of an LCD type of the display device, a color filter substrate, on a protection material disposed over the LCD glass sheet, on a lens glass (or window), and the like. The electrodes may be separate from and in addition to the display electrodes, or shared in functionality with the display electrodes. Similarly, an extra layer may be added to a display substrate or an additional process such as patterning applied to an existing layer.

In some touchpad embodiments, the sensing elements are disposed on a substrate of a touchpad. In such an embodiment, the sensor electrodes in each sensing element and/or the substrate may be substantially opaque. In some embodiments, the substrate and/or the sensor electrodes of the sensing elements may comprise a substantially transparent material. In those embodiments, where sensor electrodes of each of the sensing elements are disposed on a substrate within the display device (e.g., color filter glass, TFT glass, etc.), the sensor electrodes may be comprised of a substantially transparent material (e.g., ATO, ClearOhm™) or they may be comprised of an opaque material and aligned with the pixels of the display device.

In one configuration, the processing system 110 of the input device 200 comprises a sensor module 230 that is coupled through channels 217 to each of the transmitter and receiver electrodes, such as sensor electrodes 202 and 204, through one or more traces (e.g., traces 206 and 214) respectively. In one embodiment, the sensor module 230 is generally configured to transmit the transmitter signal and receive the resulting signals from receiver electrodes. The sensor module 230 is also generally configured to communicate the positional information received by the sensing elements to an electronic system (such as the electronic system 150 in FIG. 1) and/or a display controller (not shown), which is also coupled to the electronic system 150. The sensor module 230 may be coupled to the electronic system 150 using one or more traces that may pass through a flexible element and be coupled to the display controller using one or more traces that may pass through the same flexible element or a different connecting element. While the processing system 110 illustrated in FIG. 2 schematically illustrates a single component (e.g., IC device, controller) to form the sensor module 230, the sensor module 230 may comprise two or more controlling elements (e.g., IC devices) to control the various components in the processing system 110 of the input device 200. The controller devices may be placed onto display substrates such as TFT or Color Filter/Sealing layers (e.g. as a Chip On Glass).

In one configuration, the functions of the sensor module 230 and the display controller may be implemented in one integrated circuit that can control the display module elements and drive and/or sense data delivered to and/or received from the sensor electrodes. In various embodiments, calculation and interpretation of the measurement of the resulting signals may take place within the sensor module 230, display controller, a host electronic system 150, or some combination of the above. In some configurations, the processing system 110 may comprise a transmitter circuitry, receiver circuitry, and memory that is disposed within one or any number of ICs found in the processing system 110, depending to the desired system architecture.

The array of sensor electrode columns 203 may include a “last” sensor electrode column 205 disposed along a side of the active area 210. While FIG. 2 depicts the sensor electrode column that shares channels with the side sensor electrodes as the collection of sensor electrodes disposed closest to the side sensor electrodes, other embodiments may have other column(s) sharing the channel, such as the penultimate column. The last sensor electrode column 205 includes a plurality of sensor electrodes 204 (e.g., receiver electrodes) and a plurality of transmitter sensor electrodes 202 and 208 (e.g., 208-1, 208-2, 208-3, and so on). The sensor electrodes 202 and 208 may be disposed in alternating manner such that the sensor electrodes 208 are disposed proximate the edge of the active area 210 and the input device 100.

In one or more embodiments, the sensor electrode pattern 201 includes a plurality of sensor electrodes that area arranged and configured in a manner that supports capacitive sensing in the edge area 220. In one embodiment, the sensor electrode pattern 201 includes an array of side sensor electrodes 211 disposed on the first surface of the substrate 209 and disposed outside of the display area (e.g., active area 210). The side sensor electrodes 211 are configured to be driven with a sensing signal to detect an input object in the edge area 220 (i.e., outside of the display area, active area 210). In one embodiment, the side sensor electrodes 211 include a first plurality of electrodes 212 (e.g., 212-1, 212-2, 212-3, etc.) and a second plurality of electrodes 216, 218.

In one embodiment, one or more of the side sensor electrodes 211 share one or more channels 217 with one or more of the sensor electrodes 202, 204 in the active area 210. The channels 217 are communicatively coupled to the sensor module 230 and may include a number of transmitter channels (labeled as T1, T2, T3, T4, T5, T6, and so forth), receiver channels (labelled as R1, R2), and other channels, such as for ground or electrostatic discharge ring (depicted as coupled to grounding element 226). In some embodiments, at least one of the side sensor electrodes 211 and a sensor electrode in the last sensor electrode column 205 are coupled to a same channel. For example, sensor electrode 208-1 and side sensor electrode 212-1 are coupled to a same channel (labeled as Transmitter-2, or T2); sensor electrode 208-2 and side sensor electrode 212-2 are coupled to the same channel (T4); and sensor electrode 208-3 and side sensor electrode 212-3 are coupled to the same channel (T6).

In some embodiments, the side sensor electrodes 211 are configured to be driven (e.g., by sensor module 230) to perform transcapacitive sensing, absolute capacitive sensing, or a combination of both, to determine positional information of an input object in the edge area 220. In transcapacitive embodiments, the side sensor electrodes 211 includes a first plurality of side sensor electrodes operated as transmitter electrodes and a second plurality of side sensor electrodes operated as receiver electrodes. In the embodiment shown in FIG. 2, the side sensor electrodes 211 includes a plurality of side transmitter electrodes 212 (e.g., 212-1, 212-2, 212-3, etc.) and a plurality of side receiver electrodes 216, 218.

The side receiver electrodes 216, 218 may be arranged in a first column, and the side transmitter electrodes 212 may be arranged in a second column disposed between the first column and the last sensor electrode column 205. Traces 214 that electrically couple the side sensor electrodes 211 to the channels 217 may be disposed along an axis, e.g., the same axis as traces 206. In some embodiments, multiple side receiver electrodes 216 are coupled together by traces 224 disposed along one side of the column of side receiver electrodes, while multiple side receiver electrodes 218 are coupled together by traces 222 disposed on the opposing side of the column of side receiver electrodes. In some embodiments, as shown in FIG. 2, each side transmitter electrode 212 may be disposed in alignment with the transmitter electrodes 202, i.e., the distal ends of a side transmitter electrode 212 is aligned with distal ends of a transmitter electrode 202. In some embodiments, the side transmitter electrodes 212 and side receiver electrodes 216, 218 may be disposed along the first axis in an offset manner such that the internal, distal ends of the side sensor electrodes do not coincide.

The side sensor electrodes 211 may be sized and shaped relative to the sensor electrodes in the array of sensor electrode columns 203. In one formulation, the last sensor electrode column 205 may be considered as made of unit cells 207 of the sensing pattern 201, and the unit cells 207 can have a particular (first) dimension defined along a first axis (i.e., length). In such an embodiment, the side sensor electrodes 211 may be sized with a second dimension along the same axis that is greater than the first dimension. In other words, a side transmitter electrode 212 and/or side receiver electrodes 216, 218 may span the multiple unit cells 207 of the array of sensor electrode columns 203. For example, in the embodiment shown in FIG. 2, side transmitter electrodes 212 and side receiver electrodes 216, 218 of the side sensor electrodes 211 are sized as twice (i.e., 2×) as long as an internal pitch of the receiver sensor electrodes 204 in the array of sensor electrode columns, although other multiples or formulations may be used.

In operation, the sensor module 230 may use the transmitter channels T2, T4, and T6 to drive the side transmitter electrodes 212-1, 212-2, and 212-3, respectively, for transcapacitive sensing and receive resulting signals from side receiver electrodes 216, 218 via receiver channels R1 and R2. For example, in a first time period, the sensor module 230 may drive a first side transmitter electrode 212-1 (using channel T2) and receive resulting signals from a side receiver electrode 216 (via channel R1) and from a side receiver electrode 218 (via channel R2). In doing so, the sensor module 230 forms two separate areas of localized capacitive coupling, i.e., between the side transmitter electrode 212-1 and side receiver electrode 216, and between the side transmitter electrode 212-1 and side receiver electrode 218. This arrangement may sometimes be referred to as “1T2R”, i.e., one-transmitter-to-two-receivers, and has a higher sensing resolution and improved accuracy compared to traditional approaches. In a second time period, the sensor module 230 can drive a second side transmitter electrode 212-2 (using channel T4) and receive resulting signals from the side receiver electrodes 218 (via channel R2) and from a side receiver electrode 216 (via channel R1). It is noted that the offset configuration of the side transmitter and receiver electrodes enables a portion of a side receiver electrode to receive resulting signals from at least two different side transmitter electrodes. For example, a first portion of the side receiver electrode 218 can be used to effectively form a capacitive pixel with the side transmitter electrode 212-1, while a second portion of the side receiver electrode 218 can be used to form another capacitive pixel with a different side transmitter electrode 212-2. In other operations, the sensor module 230 uses the channels T2, T2, T6, R1 and R2 to operate the side sensor electrodes 211 (which may include any combination of side transmitter electrodes 212 and side receiver electrodes 216, 218) to perform absolute capacitive sensing to detect an input object.

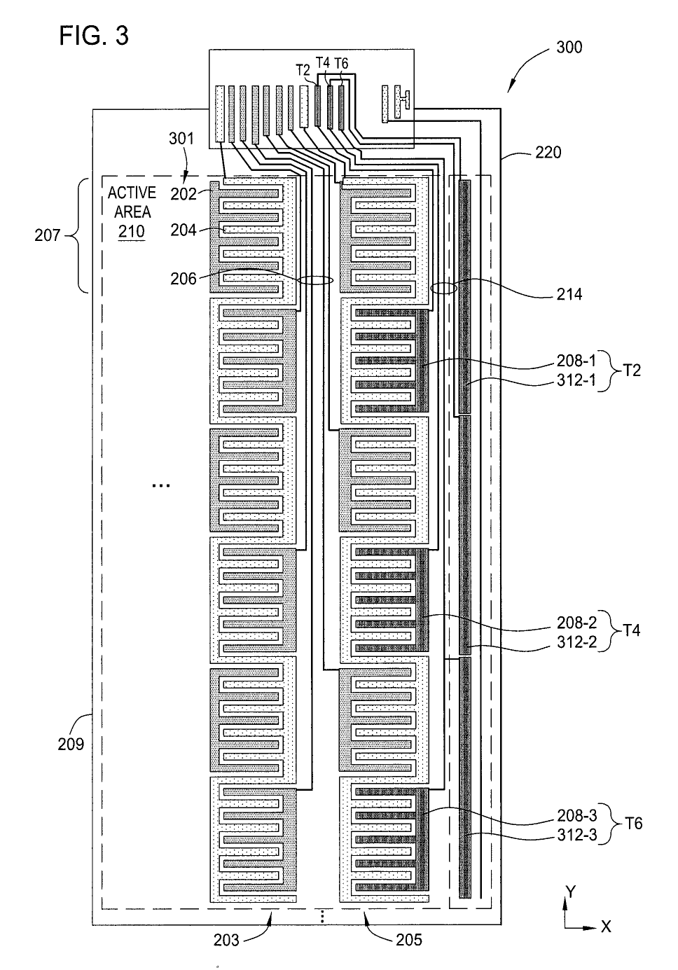

FIG. 3 is a schematic top view of a portion of an input device 300 that illustrates a portion of an alternative embodiment of a sensor electrode pattern 301. The sensor electrode pattern 301 may be used to determine the positional information of an input object within a sensing region that includes an active area 210 and an edge area 220. The processing system 110, among other elements, is omitted for simplicity of illustration. The sensor electrode pattern 301 is similar to the sensor electrode pattern 201 discussed above, except that the sensor electrode pattern 301 includes a single array of side sensor electrodes, e.g., side sensor electrodes 312, disposed in the edge area 220. The described embodiment of having a single array of side sensor electrodes provides for capacitive sensing in the edge area 220 using a narrow edge design. The use of a narrow edge design, in contrast to other patterns, enables the sensor electrode pattern 301 to further include a second array of side sensor electrodes on a different side of the input device 300, such as in a second edge area opposite the first edge area 220 of the input device 300.

As shown in FIG. 3, the sensor electrode pattern 301 includes a plurality of side sensor electrodes 312 (e.g., 312-1, 312-2, 312-3, etc.) arranged in a column in an edge area 220 of the input device 300. Similar to the sensor electrode pattern 201, in some embodiments, the array of side sensor electrodes 312 can be disposed near a bezel of the input device 300, and the side sensor electrodes 312 are configured to be driven with the sensing signal to detect the input object proximate to the bezel of the input device 300. In other embodiments, the array of side sensor electrodes are disposed on a side edge of the input device 300, and the side sensor electrodes are configured to be driven with the sensing signal to detect the input object proximate to the side edge of the host device. Each of the side sensor electrodes 312 share an input channel with a corresponding transmitter electrode 208. For example, the side sensor electrode 312-1 and the transmitter electrode 208-1 share an input channel T2; the side sensor electrode 312-2 and the transmitter electrode 208-2 share an input channel T4; and the side sensor electrode 312-3 and the transmitter electrode 208-3 share the input channel T6.

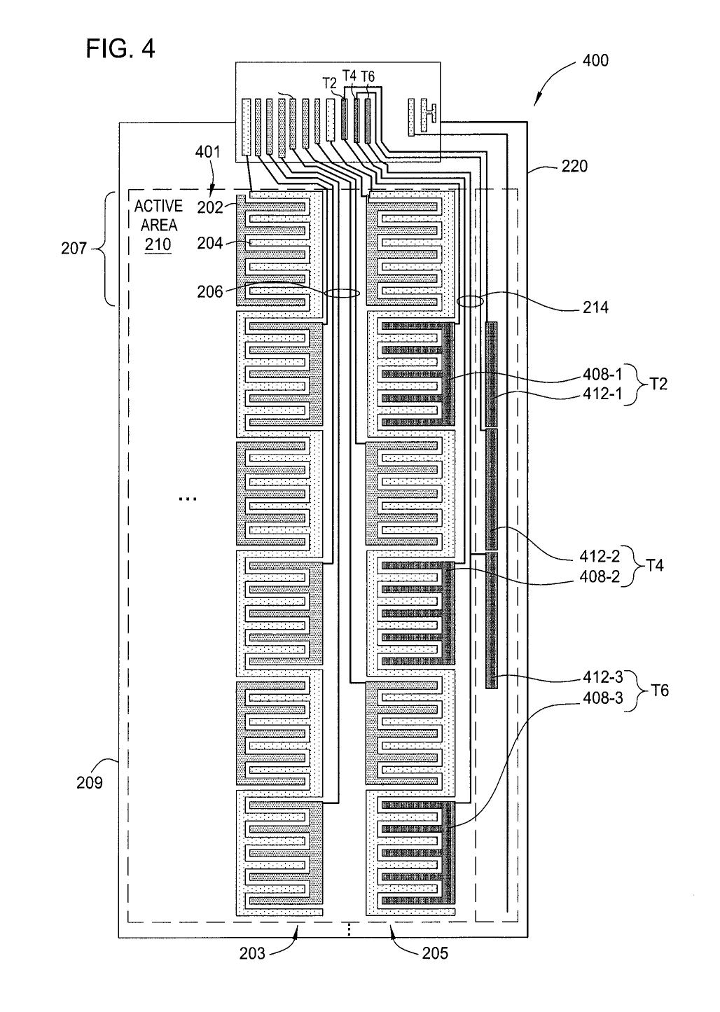

In one or more embodiments, each of the side sensor electrodes 312 is sized relative to the sensor electrodes in the array of sensor electrode columns 203. In the embodiment depicted in FIG. 3, one dimension of unit cells 207 of the array of sensor electrodes 203 along one axis can be referred to as an internal pitch (e.g., along the Y-axis), and the side sensor electrodes 312 may be sized to have double the length as the pitch of the sensor electrodes within the active area 210 of the input device 300. It is understood that other configurations and arrangements may be used, as shown in FIG. 4.

FIG. 4 is a schematic top view of a portion of an input device 400 that illustrates a portion of an alternative embodiment of a sensor electrode pattern 401, having a different sizing of side sensor electrodes. The sensor electrode pattern 401 is similar to the sensor electrode pattern 301 discussed above, except that the sensor electrode pattern 401 includes an array of side sensor electrodes 412 having a size equal or substantially similar to the dimensions of the sensor electrodes within the active area 210. That is, the side sensor electrodes 412 may have the same length as the pitch of the sensor electrodes within the active area 210 of the input device 400. This allows higher resolution capacitive sensing with the same number of electrodes, but over a smaller region. In other embodiments, sensor electrodes of varying lengths may be used to perform capacitive sensing at a variety of resolutions over a portion, or the entire side, of the input device 400.

The embodiments and examples set forth herein were presented in order to best explain the embodiments in accordance with the present technology and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

In view of the foregoing, the scope of the present disclosure is determined by the claims that follow.

We claim:

1. A single layer capacitive sensor, comprising:
a substrate;
an array of sensor electrode columns disposed on a first surface of the substrate and disposed along a first axis in a display area, wherein the array of sensor electrode columns includes a last sensor electrode column disposed along a side of the display area, wherein each sensor electrode column comprises:
a first plurality of sensor electrodes,
a second plurality of sensor electrodes,
one or more routing traces extending along the first axis coupling to the first plurality of sensor electrodes, and
one or more routing traces extending along the first axis coupling to the second plurality of sensor electrodes; and
an array of side sensor electrodes disposed on the first surface and disposed outside of the display area, wherein the side sensor electrodes are configured to be driven with a sensing signal to detect an input object outside of the display area, wherein at least one of the side sensor electrodes and a sensor electrode in the last sensor electrode column are coupled to a same channel.

2. The single layer capacitive sensor of claim 1, wherein the array of side sensor electrodes disposed out of the display area comprises a column of side transmitter electrodes, wherein at least one side transmitter electrode is coupled to the same channel as one of the first plurality of sensor electrodes of the last sensor electrode column.

3. The single layer capacitive sensor of claim 1, wherein the array of side sensor electrodes disposed out of the display area comprises:
at least one side transmitter electrode and at least one side receiver electrode, wherein the side transmitter electrode is coupled to the same channel as one of the first plurality of sensor electrodes of the last sensor electrode column.

4. The single layer capacitive sensor of claim 3, wherein the at least one side receiver electrode in the array of side sensor electrodes is arranged in a first column and the at least one side transmitter electrode is arranged in a second column between the first column and the last sensor electrode column.

5. The single layer capacitive sensor of claim 1, wherein the last sensor electrode column comprises:
a plurality of unit cells of a sensing pattern, the plurality of unit cells having a pitch of a first dimension along the first axis, and
wherein each transmitter electrode of the side sensor electrodes has a second dimension along the first axis, wherein the second dimension is greater than the first dimension.

6. The single layer capacitive sensor of claim 1, wherein the array of side sensor electrodes are configured to be driven to perform one of absolute capacitive sensing, and transcapacitive sensing.

7. The single layer capacitive sensor of claim 1, wherein the array of side sensor electrodes is a first array of side sensor electrodes disposed on a first edge area of a host device,
wherein the single layer capacitive sensor further comprises a second array of side sensor electrodes disposed on a second edge area opposite the first edge area of the host device.

8. The single layer capacitive sensor of claim 1, wherein the array of side sensor electrodes are disposed near a bezel of a host device, wherein the side sensor electrodes are configured to be driven with the sensing signal to detect the input object proximate to the bezel of the host device.

9. The single layer capacitive sensor of claim 1, wherein the array of side sensor electrodes are disposed on a side edge of a host device, wherein the side sensor electrodes are configured to be driven with the sensing signal to detect the input object proximate to the side edge of the host device.

10. An input device, comprising:
an array of sensor electrode columns disposed on a first surface of a substrate and disposed along a first axis in a display area, wherein the array of sensor electrode columns includes a last sensor electrode column disposed along a side of the display area, wherein each sensor electrode column comprises:
a first plurality of sensor electrodes,
a second plurality of sensor electrodes,
one or more routing traces extending along the first axis coupling to the first plurality of sensor electrodes, and
one or more routing traces extending along the first axis coupling to the second plurality of sensor electrodes;
an array of side sensor electrodes disposed on the first surface of the substrate and disposed outside of the display area; and
a processing system communicatively coupled to the array of sensor electrode columns and the array of side sensor electrodes, wherein at least one of the side sensor electrodes and a sensor electrode in the last sensor electrode column are coupled to a same channel, wherein the processing system is configured to drive the side sensor with a sensing signal to detect an input object outside of the display area.

11. The input device of claim 10, wherein the array of side sensor electrodes disposed out of the display area comprises a column of side transmitter electrodes, wherein at least one side transmitter electrode is coupled to the same channel as one of the first plurality of sensor electrodes of the last sensor electrode column.

12. The input device of claim 10, wherein the array of side sensor electrodes disposed out of the display area comprises:
at least one side transmitter electrode and at least one side receiver electrode, wherein the side transmitter electrode is coupled to the same channel as one of the first plurality of sensor electrodes of the last sensor electrode column.

13. The input device of claim 12, wherein the at least one side receiver electrode in the array of side sensor electrodes is arranged in a first column and the at least one side transmitter electrode is arranged in a second column between the first column and the last sensor electrode column.

14. The input device of claim 10, wherein the last sensor electrode column comprises:
a plurality of unit cells of a sensing pattern, the plurality of unit cells having a pitch of a first dimension along the first axis, and
wherein each transmitter electrode of the side sensor electrodes has a second dimension along the first axis, wherein the second dimension is greater than the first dimension.

15. The input device of claim 10, wherein the array of side sensor electrodes are configured to be driven to perform one of absolute capacitive sensing and transcapacitive sensing.

16. The input device of claim 10, wherein the array of side sensor electrodes is a first array of side sensor electrodes disposed on a first edge area of a host device,
wherein the single layer capacitive sensor further comprises a second array of side sensor electrodes disposed on a second edge area opposite the first edge area of the host device.

17. The input device of claim 10, wherein the array of side sensor electrodes are disposed near a bezel of the input device, wherein the side sensor electrodes are configured to be driven with the sensing signal to detect the input object proximate to the bezel of the input device.

18. The input device of claim 10, wherein the array of side sensor electrodes are disposed on a side edge of a input device, wherein the side sensor electrodes are configured to be driven with the sensing signal to detect the input object proximate to the side edge of the input device.

19. A processing system, comprising:
a sensor module comprising sensor circuitry, wherein the sensor module is configured to be coupled to an array of sensor electrode columns disposed on a first surface of a substrate and disposed along a first axis in a display area, wherein the array of sensor electrode columns includes a last sensor electrode column disposed along a side of the display area,
wherein the sensor module is configured to be coupled to a first plurality of sensor electrodes of each sensor electrode column via one or more routing traces extending along the first axis,
wherein the sensor module is configured to be coupled to a second plurality of sensor electrodes of each sensor electrode column via one or more routing traces extending along the first axis,
wherein the sensor module is configured to be coupled an array of side sensor electrodes disposed on the first surface and disposed outside of the display area and drive the side sensor electrodes with a sensing signal to detect an input object outside of the display area, and
wherein the sensor module is configured to be coupled to at least one of the side sensor electrodes and a sensor electrode in the last sensor electrode column at a same channel of the sensor module.

20. The processing system of claim 19, wherein the sensor module is configured to drive the array of side sensor electrodes to perform at least one of transcapacitive sensing and absolute capacitive sensing.
